(19) United States
(12) Patent Application Publication
(10) Pub. No.: US 2014/0014753 A1
(43) Pub. Date: Jan. 16, 2014

(54) SHREDDER WITH FEEDING GAP ADJUSTING DEVICE

(71) Applicant: JIAN HUA ZHEN, Taipei (TW)

(72) Inventor: JIAN HUA ZHEN, Taipei (TW)

(73) Assignee: Primax Electronics Ltd., Taipei (TW)

(21) Appl. No.: 13/617,163

(22) Filed: Sep. 14, 2012

(30) Foreign Application Priority Data
Jul. 13, 2012 (CN) 201210243247.7

(51) Int. Cl. B02C 18/22

(52) U.S. Cl. 241/222

(57) ABSTRACT

A shredder includes an adjusting device for adjusting a feeding gap, so that the width of the feeding gap does not exceed a maximum shredding thickness value. The adjusting device is located at a side of the feeding channel. A roller is located at another side of the feeding channel. The feeding gap is formed between the adjusting device and the roller. After the papers in the feeding channel are transferred through the feeding gap, the papers are cut into strips or fine particles by a cutting blade assembly. By rotating a fixing element of the adjusting device, the width of the feeding gap is changed to comply with the maximum shredding thickness value. Consequently, it is not necessary to change the relative positions between the first lateral plate and the second lateral plate, which collaboratively define the feeding channel.

### FIELD OF THE INVENTION

The present invention relates to a shredder, and more particularly to a shredder capable of adjusting a width of a feeding gap according to a maximum shredding thickness value.

### BACKGROUND OF THE INVENTION

A shredder is an office machine widely used to cut a document into strips or fine particles in order to prevent the confidential data of the document from being leaked. Generally, the shredder has two parallel rotating shafts. Plural cutting blades are sheathed around each of the two rotating shafts. The two parallel rotating shafts are driven by a motor and a gear set to be rotated in opposite directions. After the papers to be cut are placed in a paper entrance and the shredder is turned on, the papers are moved downwardly and transferred through the cutting blades to be cut into strips or fine particles. Depending on the loading of the motor, the strength of the rotating shafts and the strength of the cutting blades, the maximum allowable thickness value of the papers that can be processed by the shredder at one time is varied. Consequently, for destroying many papers, the number of papers to be placed in the paper entrance is restricted by the maximum paper thickness value. If the thickness of the papers exceeds the maximum allowable thickness value, the cutting blades fail to cut the papers into strips or fine particles. Under this circumstance, the paper shredding operation of the shredder is stopped or even the shredder is damaged. Consequently, it is important to prevent the papers with a thickness higher than the maximum paper thickness value from being transferred through the plural cutting blades.

A method for allowing the papers in the paper entrance of the conventional shredder to comply with the maximum paper thickness value of the shredder will be illustrated as follows.

First of all, the components of the conventional shredder will be illustrated with reference to FIG. 1. FIG. 1 is a schematic cross-sectional view illustrating a conventional shredder.

As shown in FIG. 1, the shredder 1 comprises an upper cover 11, a first elastic movable plate 12, a second elastic movable plate 13, an adjusting device 14, and a core portion 15. The upper cover 11 has a perforation 111. The core portion 15 comprises a cutting blade assembly 151.

A sequence of the conventional shredder will be illustrated as follows. Please refer to FIG. 1 again. Firstly, the first elastic movable plate 12 and the second elastic movable plate 13 are respectively fixed on the inner surfaces of the upper cover 11 at bilateral sides of the perforation 111 through the adjusting device 14. Consequently, a paper entrance 10 is formed between the first elastic movable plate 12 and the second elastic movable plate 13. Then, the core portion 15 is disposed within the shredder 1 and directly located under the paper entrance 10. Consequently, the cutting blade assembly 151 and the paper entrance 10 are arranged on the same vertical plane.

The operations of the conventional shredder will be illustrated as follows. After the papers to be cut are placed in the paper entrance 10 and the shredder 1 is turned on, the cutting blade assembly 151 of the core portion 15 is rotated, and the papers downwardly transferred through the cutting blade assembly 151 are cut into strips or fine particles by the rotated cutting blade assembly 151. Generally, the maximum number of papers to be placed in the paper entrance 10 at one time is determined according to the width of the paper entrance 10. That is, according to the maximum allowable thickness value of the papers that can be processed by the shredder 1 at one time, before the shredder 1 leaves the factory, the positions of the first elastic movable plate 12 and the second elastic movable plate 13 are adjusted through the adjusting device 14. Consequently, the width of the paper entrance 10 is substantially equal to the maximum allowable thickness value of the papers that can be processed by the shredder 1 at one time.

However, the conventional shredder 1 still has some drawbacks. As previously described, the shredder 1 is additionally equipped with the first elastic movable plate 12 and the second elastic movable plate 13 in order to adjust the width of the paper entrance 10. Since the paper entrance for most of the commercially available shredders is formed between two fixed lateral plates. The positions of the lateral plates fail to be adjusted. In addition, there is no additional space for accommodating the elastic movable plates. In other words, the method for adjusting the width of the paper entrance of the conventional shredder 1 is not feasible to most of the commercially available shredders.

Therefore, there is a need of providing an improved shredder in order to eliminate the above drawbacks.

### SUMMARY OF THE INVENTION

In accordance with an aspect of the present invention, there is provided a shredder with a feeding gap adjusting device. The shredder has a maximum shredding thickness value. The shredder includes a casing, a feeding channel, an adjusting device, a roller, and a cutting blade assembly. The casing includes a first lateral plate and a second lateral plate. The feeding channel is arranged between the first lateral plate and the second lateral plate for accommodating at least one paper. The adjusting device is located at a first side of the first lateral plate for adjusting a width of a feeding gap, so that the width of the feeding gap complies with the maximum shredding thickness value. The adjusting device includes an accommodation portion, a first elastic element, a stopping block, and a fixing element. The first elastic element is accommodated within the accommodation portion. The stopping block is used for compressing the first elastic element. The stopping block is partially penetrated through the first lateral plate and exposed to the feeding channel. The fixing element is penetrated through the accommodation portion and the first elastic element and connected with the stopping block. In addition, the fixing element is rotatable relative to the stopping block. The roller is penetrated through the second lateral plate and partially exposed to the feeding channel. The roller is directly aligned with the stopping block. Moreover, the feeding gap is formed between the stopping block and the roller. The cutting blade assembly is disposed under the feeding channel. When the at least one paper is transferred through a region between the stopping block and the roller, the at least one paper is cut by the cutting blade assembly. By rotating the fixing element, the width of the feeding gap is correspondingly adjusted.

In an embodiment, the accommodation portion further includes two sliding grooves. The two sliding grooves are disposed within the accommodation portion. The stopping block further includes two ribs. The two ribs are disposed on an outer surface of the stopping block and respectively engaged with the two sliding grooves. Upon rotation of the fixing element, the stopping block is fixed within the accommodation portion through the two sliding grooves, so that the stopping block is not rotated with the fixing element.

In an embodiment, the stopping block further includes a screw hole. The fixing element is a screw, and the fixing element is tightened in the screw hole.

In an embodiment, the adjusting device further includes a first bracket. The first bracket is fixed on a position at the first side of the first lateral plate. The accommodation portion is formed in the first bracket.

In an embodiment, the shredder further includes a second bracket. The second bracket is fixed on a position at a second side of the second lateral plate. The roller is pivotally coupled to the second bracket.

In an embodiment, a distance between the stopping block and the roller is equal to the maximum shredding thickness value.

In an embodiment, a distance between the stopping block and the roller is smaller than the maximum shredding thickness value.

In an embodiment, the shredder further includes a thickness detecting device. The thickness detecting device includes a linking rod, a sheltering member, and a sensing member. The linking rod is pivotally coupled to the roller and comprising plural first toothed structures. The sheltering member includes a rotating disc and a detecting plate. The rotating disc includes plural second toothed structures. The plural second toothed structures are engaged with the plural first toothed structures, wherein the detecting plate is connected with the rotating disc. The sensing member includes a transmitting part for generating a sensing signal and a receiving part for receiving the sensing signal. Moreover, the at least one paper includes plural papers. When the plural papers are introduced into the feeding gap, the roller and the linking rod are pushed by the plural papers, so that the rotating disc is correspondingly rotated and the detecting plate is swung. Moreover, if the thickness of the plural papers exceeds the maximum shredding thickness value, the sensing signal is blocked by the detecting plate.

In an embodiment, the thickness detecting device further includes a second bracket and a second elastic element. The second bracket is fixed on a position at a second side of the second lateral plate. The linking rod, the sheltering member and the sensing member are all disposed within the second bracket. In addition, the second elastic element is connected with the linking rod and sustained against the second bracket.

In an embodiment, the stopping block has a first end and a second end. The first elastic element is compressed by the first end of the stopping block. The second end of the stopping block is exposed to the feeding channel. The second end of the stopping block has a slant surface for facilitating the at least one paper to pass through.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a conventional shredder;

FIG. 2 is a schematic perspective view illustrating a shredder according to a first embodiment of the present invention;

FIG. 3 is a schematic cutaway view illustrating the shredder according to the first embodiment of the present invention;

FIG. 4 is a schematic cross-sectional side view illustrating the shredder according to the first embodiment of the present invention;

FIG. 5 is a schematic perspective view illustrating the relationship between the adjusting device, the roller and the second bracket of the shredder according to the first embodiment of the present invention;

FIG. 6 is a schematic exploded view illustrating the adjusting device of the shredder according to the first embodiment of the present invention and taken along a first viewpoint;

FIG. 7 is a schematic exploded view illustrating the adjusting device of the shredder according to the first embodiment of the present invention and taken along a second viewpoint;

FIG. 8 is a schematic cutaway view illustrating the adjusting device of the shredder according to the first embodiment of the present invention;

FIG. 9 is a schematic cross-sectional side view illustrating a shredder according to a second embodiment of the present invention;

FIG. 10 is a schematic perspective view illustrating the relationship between the adjusting device, the roller and the thickness detecting device of the shredder according to the second embodiment of the present invention;

FIG. 11 is a schematic exploded view illustrating the thickness detecting device of the shredder according to the second embodiment of the present invention; and

FIG. 12 is another schematic exploded view illustrating the thickness detecting device of the shredder according to the second embodiment of the present invention.

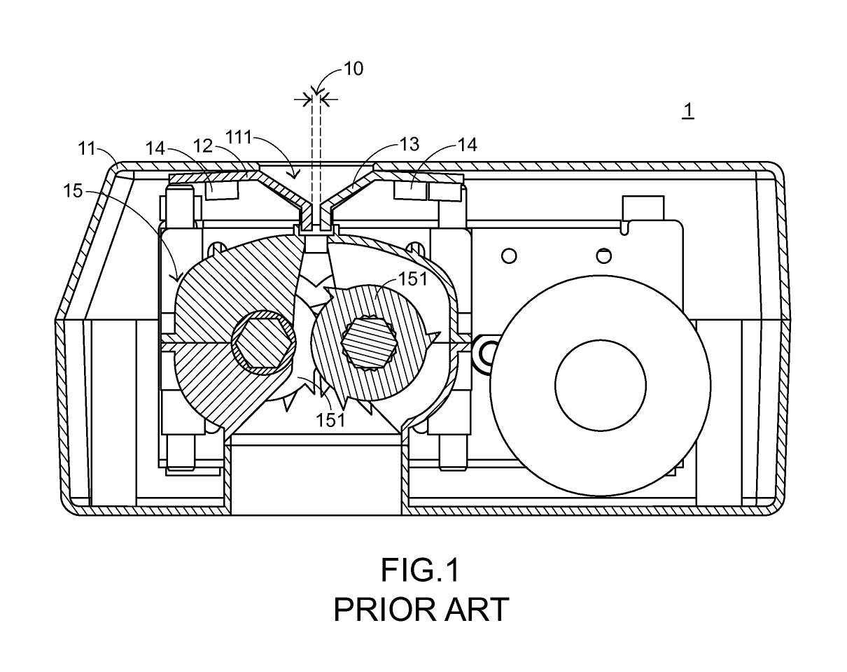

### DETAILED DESCRIPTION OF THE PREFERRED EMBODIMENT

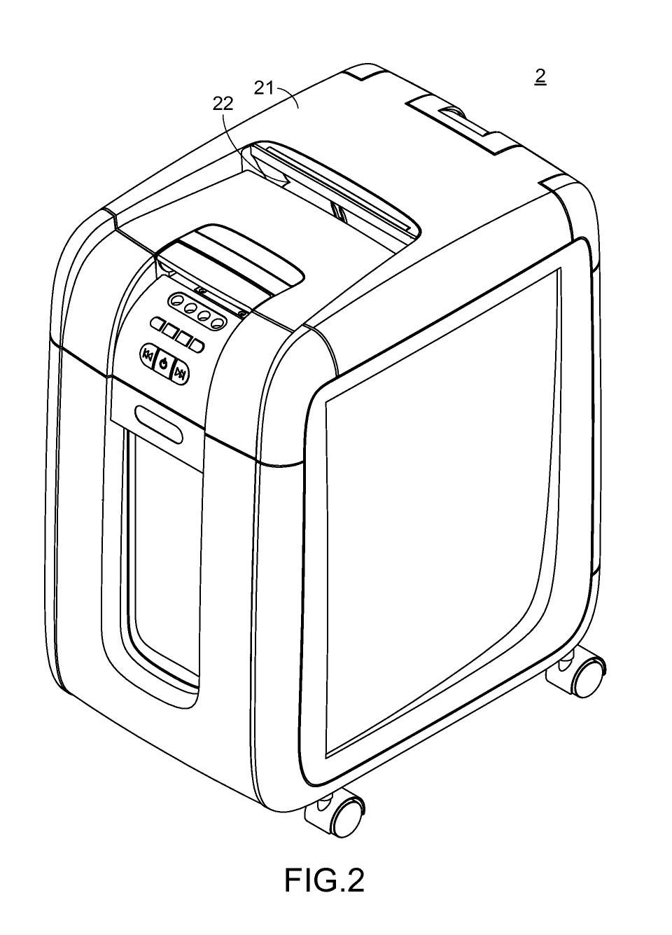

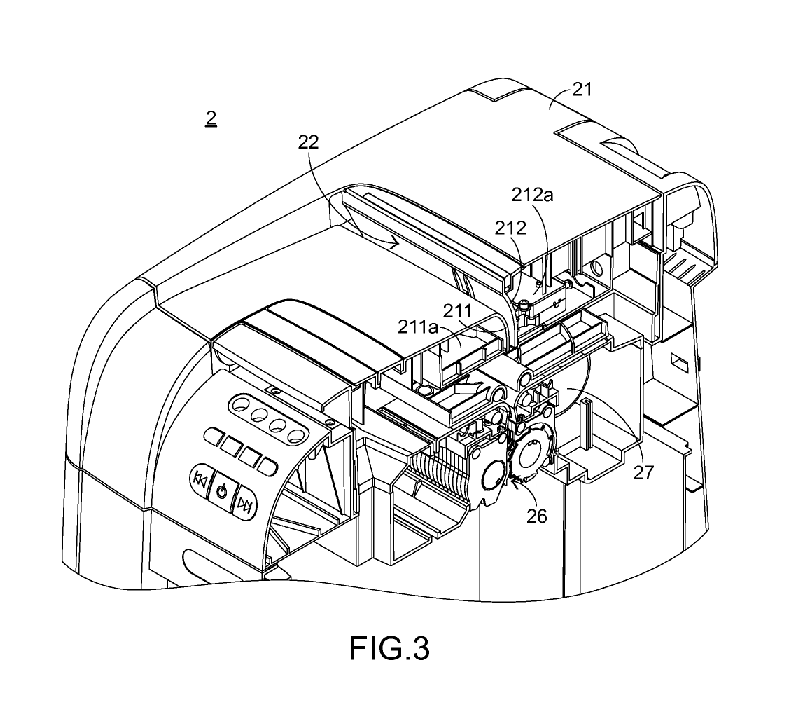

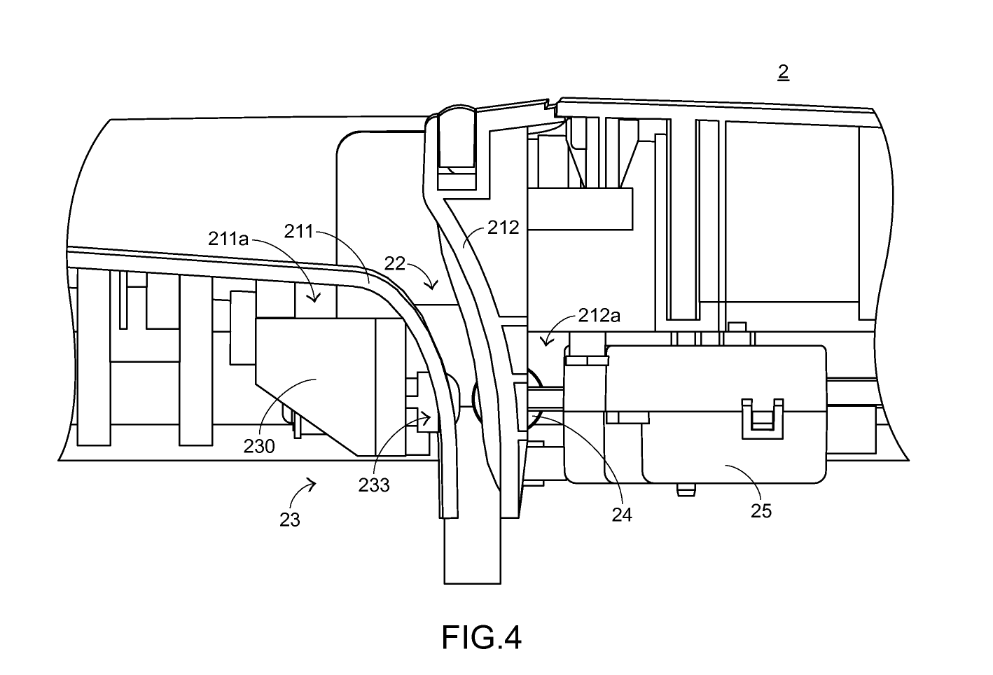

The present invention provides a shredder. Hereinafter, the components of the shredder according to a first embodiment of the present invention will be illustrated with reference to FIGS. 2, 3 and 4. FIG. 2 is a schematic perspective view illustrating a shredder according to a first embodiment of the present invention. FIG. 3 is a schematic cutaway view illustrating the shredder according to the first embodiment of the present invention. FIG. 4 is a schematic cross-sectional side view illustrating the shredder according to the first embodiment of the present invention. As shown in FIGS. 2, 3 and 4, the shredder 2 comprises a casing 21, a feeding channel 22, an adjusting device 23, a roller 24, a second bracket 25, a cutting blade assembly 26, and a motor 27. The casing 21 comprises a first lateral plate 211 and a second lateral plate 212.

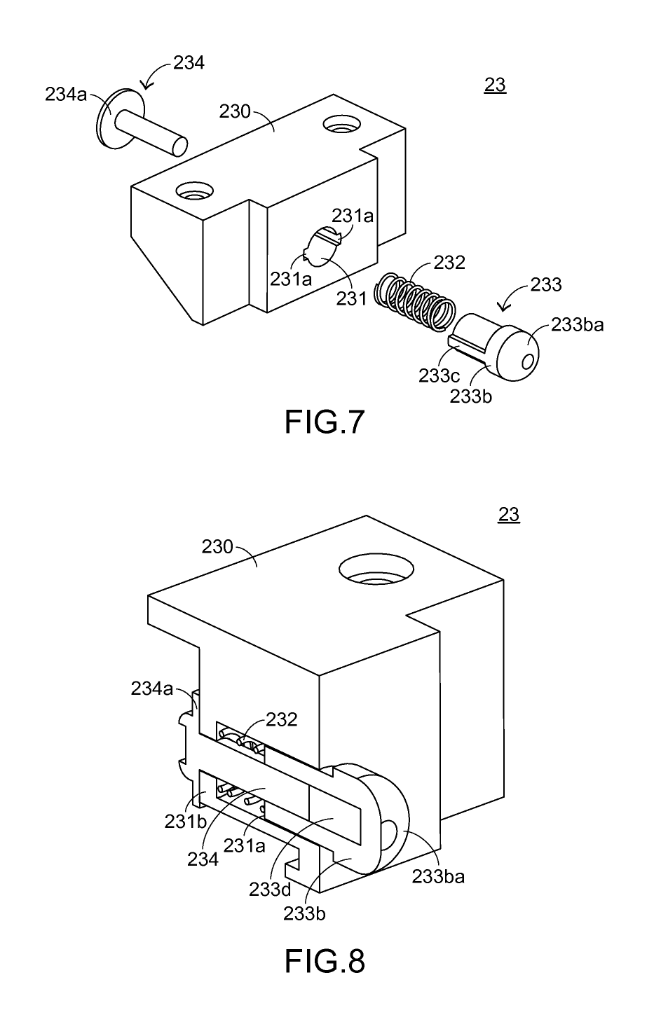

FIG. 6 is a schematic exploded view illustrating the adjusting device of the shredder according to the first embodiment of the present invention and taken along a first viewpoint. FIG. 7 is a schematic exploded view illustrating the adjusting device of the shredder according to the first embodiment of the present invention and taken along a second viewpoint. As shown in FIGS. 6 and 7, the adjusting device 23 comprises a first bracket 230, an accommodation portion 231, a first elastic element 232, a stopping block 233, and a fixing element 234. The accommodation portion 231 comprises two sliding grooves 231a. The stopping block 233 comprises a first end 233a, a second end 233b, two ribs 233c, and a screw hole 233d. The second end 233b of the stopping block 233 has a slant surface 233ba. Moreover, the fixing element 234 is a screw with a head part 234a.

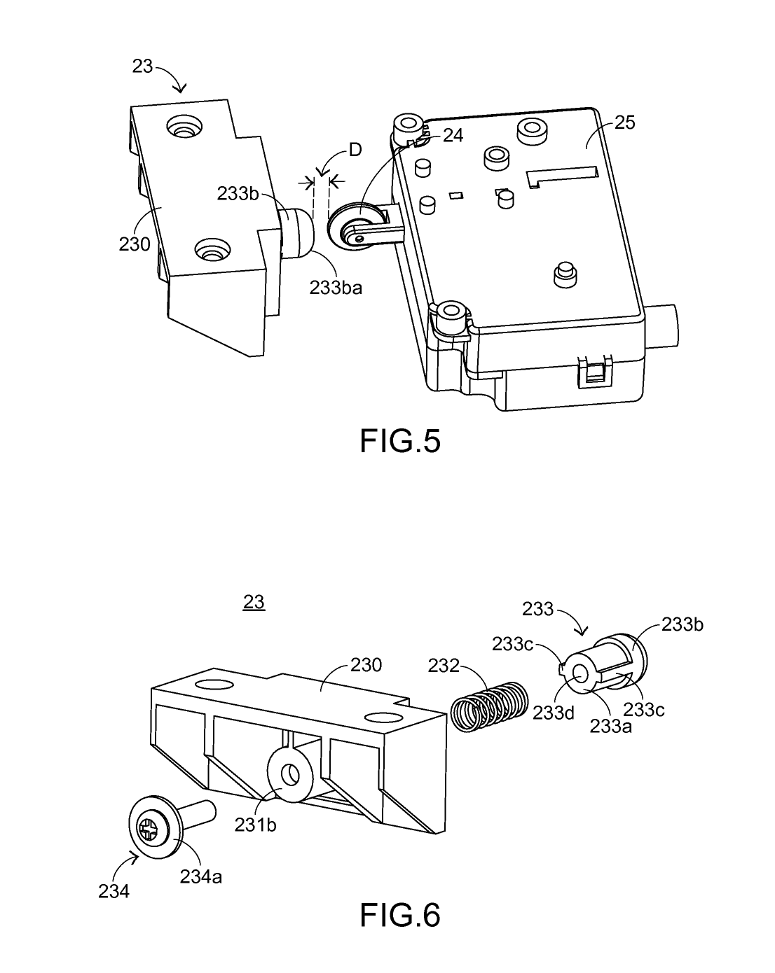

FIG. 5 is a schematic perspective view illustrating the relationship between the adjusting device, the roller and the second bracket of the shredder according to the first embodiment of the present invention. Hereinafter, a process of assembling the shredder 2 according to the first embodiment of the present invention will be illustrated with reference to FIGS. 3, 4 and 5. Firstly, the feeding channel 22 is arranged between the first lateral plate 211 and the second lateral plate 212 of the casing 21. Then, the first bracket 230 of the adjusting device 23 is fixed on a position at a first side 211a of the first lateral plate 211. The stopping block 233 is penetrated through the first lateral plate 211 and partially exposed to the feeding channel 22. The second bracket 25 is fixed on a position at a second side 212a of the second lateral plate 212. The roller 24 is pivotally coupled to the second bracket 25. Moreover, the roller 24 is penetrated through the second lateral plate 212 and partially exposed to the feeding channel 22. Moreover, the roller 24 is directly aligned with the stopping block 233. The cutting blade assembly 26 is disposed under the feeding channel 22. The motor 27 is connected with the cutting blade assembly 26 through a gear set (not shown) in order to drive the cutting blade assembly 26.

FIG. 8 is a schematic cutaway view illustrating the adjusting device of the shredder according to the first embodiment of the present invention. Hereinafter, a process of assembling the adjusting device 23 of the shredder 2 according to the first embodiment of the present invention will be illustrated with reference to FIGS. 6, 7 and 8. Firstly, the accommodation portion 231 is formed in the first bracket 230. The two sliding grooves 231a are disposed within the accommodation portion 231. The two ribs 233c are disposed on an outer surface of the stopping block 233. The screw hole 233d is located at the first end 233a of the stopping block 233.

Then, the first elastic element 232 is accommodated within the accommodation portion 231 and contacted with an inner wall 231b of the accommodation portion 231. The stopping block 233 is inserted into the accommodation portion 231. The first elastic element 232 is compressed by the first end 233a of the stopping block 233. The two ribs 233c of the stopping block 233 are respectively engaged with the two sliding grooves 231a of the accommodation portion 231. In addition, the second end 233b of the stopping block 233 is exposed outside the accommodation portion 231.

The fixing element 234 is penetrated through the inner wall 231b of the accommodation portion 231 and the first elastic element 232, and then connected with the screw hole 233d of the stopping block 233. Since the fixing element 234 is a screw, the fixing element 234 is tightened in the screw hole 233d of the stopping block 233, and the fixing element 234 is rotated relative to the stopping block 233 to be spun in or spun out of the screw hole 233d.

More importantly, a feeding gap D is formed between the stopping block 233 and the roller 24. After the papers in the feeding channel 22 are transferred through the feeding gap D, the papers are cut into strips or fine particles by the cutting blade assembly 26.

It is noted that the second end 233b of the stopping block 233 has a slant surface 233ba. During the papers are transferred through the feeding gap D, due to the slant surface 233ba of the second end 233b of the stopping block 233, the papers can be transferred through the feeding gap D more easily. Moreover, during the papers are transferred through the feeding gap D, the roller 24 is pushed and rotated by the papers in order to assist in moving the papers forwardly.

The operating principles of the shredder according to the first embodiment will be illustrated as follows. Firstly, according to the loading of the motor 27 and the strength of the cutting blade assembly 26, the thickness of the papers that are cut into strips or fine particles by the shredder 2 at one time is determined. In other words, a maximum shredding thickness value of the shredder 2 indicates the maximum allowable thickness value of the papers that can be processed by the shredder 2 at one time.

As mentioned above, after the papers are transferred through the feeding gap D, the papers are cut into strips or fine particles by the cutting blade assembly 26. Consequently, by adjusting the width of the feeding gap D to comply with the maximum shredding thickness value of the shredder 2, the thickness of the papers to be cut by the cutting blade assembly 26 does not exceed the maximum shredding thickness value.

A method for adjusting the width of the feeding gap D will be illustrated as follows. Firstly, since the first elastic element 232 is compressed by the stopping block 233, a supporting force is exerted on the stopping block 233 by the first elastic element 232. Consequently, if the relative positions between the stopping block 233 and the fixing element 234 are unchanged, a first terminal of the first elastic element 232 is sustained against the inner wall 231b of the accommodation portion 231. In addition, the stopping block 233 is pushed by a second terminal of the first elastic element 232 to be moved in the direction toward the roller 24 until the head part 234a of the fixing element 234 is stopped by the inner wall 231b of the accommodation portion 231.

Upon rotation of the fixing element 234, if the fixing element 234 is spun out of the screw hole 233d, the distance between the head part 234a of the fixing element 234 and the first end 233a of the stopping block 233 is increased. Under this circumstance, the stopping block 233 is pushed by the first elastic element 232 to be moved in the direction toward the roller 24, and thus the width of the feeding gap D is decreased.

On the other hand, if the fixing element 234 is spun into the screw hole 233d, the distance between the head part 234a of the fixing element 234 and the first end 233a of the stopping block 233 is decreased. Under this circumstance, the first elastic element 232 is further compressed by the stopping block 233, and the stopping block 233 is moved in the direction distant from the roller 24. Consequently, the width of the feeding gap D is increased.

Moreover, since the two ribs 233c of the stopping block 233 are respectively engaged with the two sliding grooves 231a of the accommodation portion 231, when the fixing element 234 is rotated, the two ribs 233c are only permitted to be horizontally moved along the two sliding grooves 231a. In such way, the stopping block 233 is not synchronously rotated with the fixing element 234.

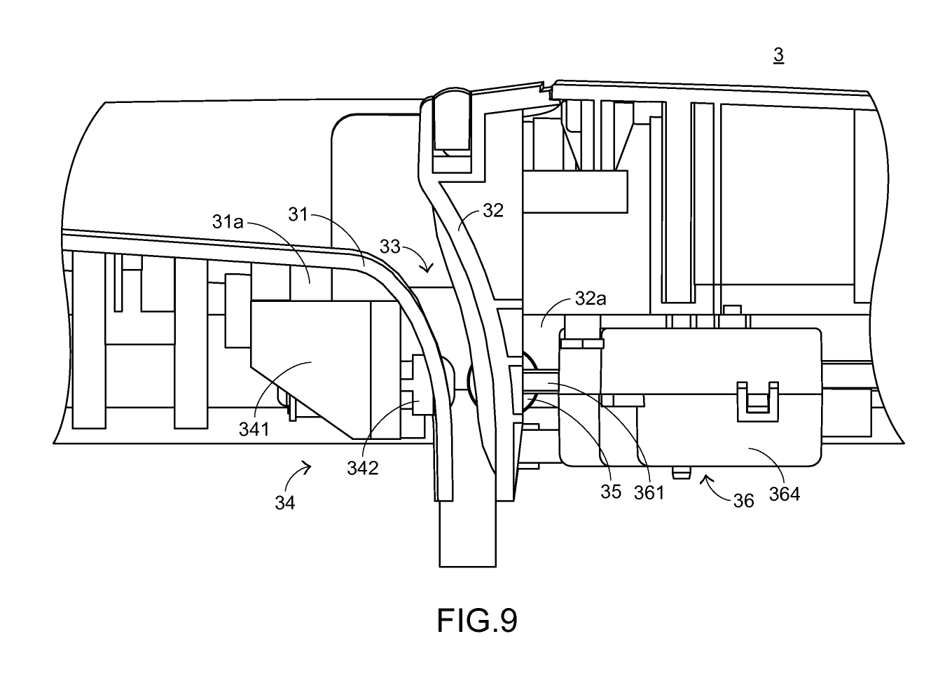

The present invention further provides a shredder of a second embodiment. In comparison with the first embodiment, the shredder of the second embodiment further comprises a thickness detecting device. FIG. 9 is a schematic cross-sectional side view illustrating a shredder according to a second embodiment of the present invention. The components of the shredder 3 comprise a first lateral plate 31, a second lateral plate 32, a feeding channel 33, an adjusting device 34, a roller 35, and a thickness detecting device 36.

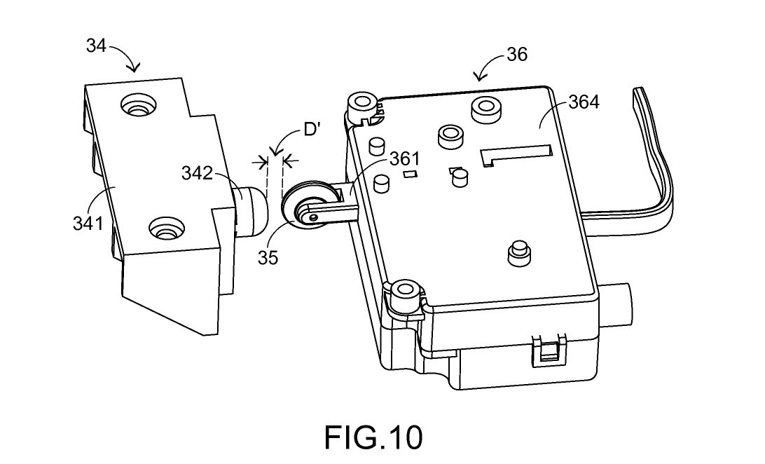

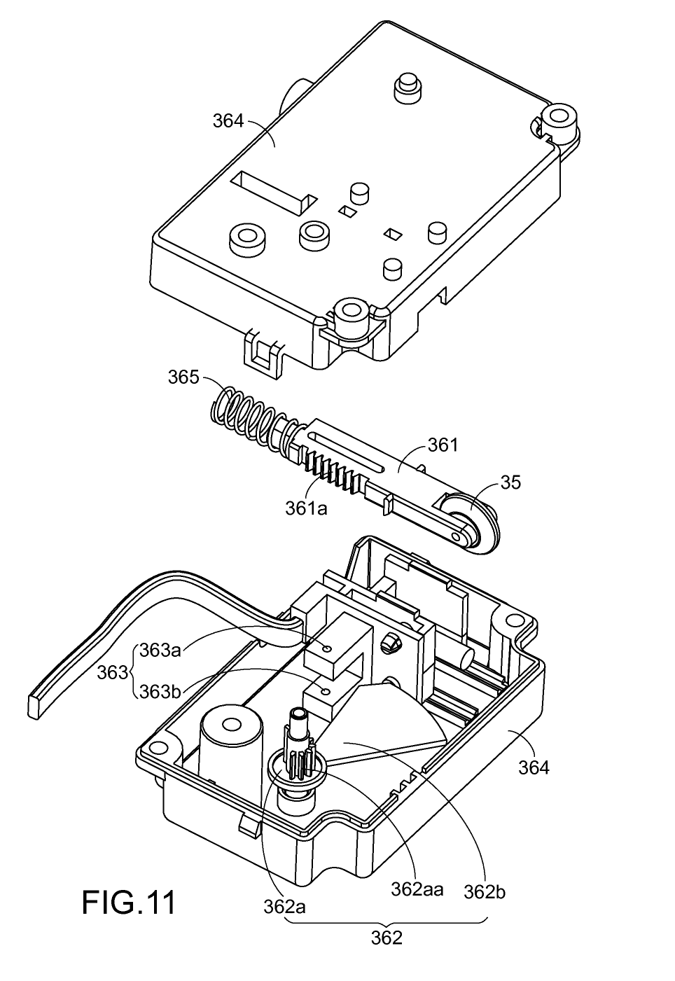

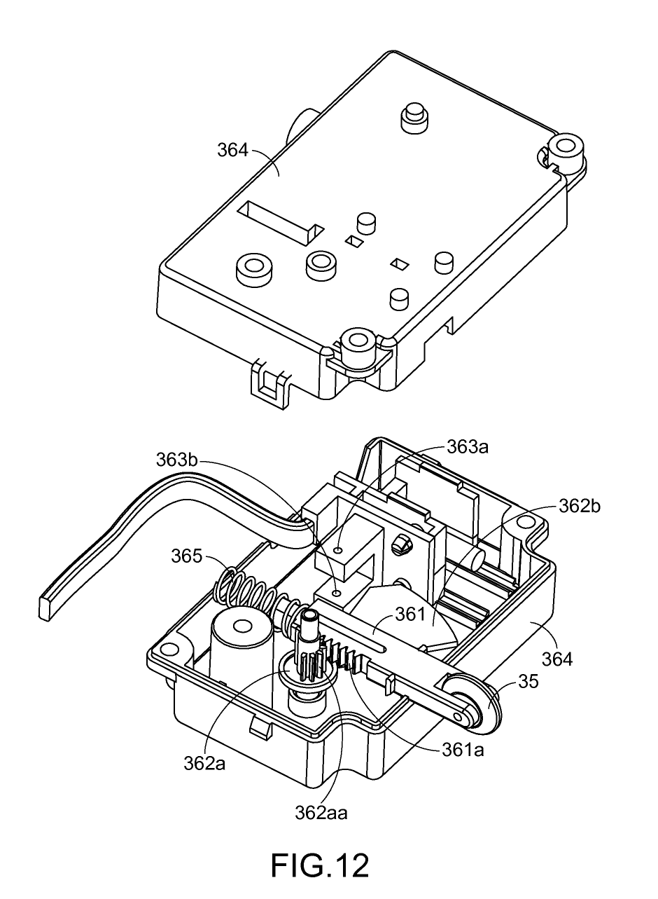

FIG. 10 is a schematic perspective view illustrating the relationship between the adjusting device, the roller and the thickness detecting device of the shredder according to the second embodiment of the present invention. FIG. 11 is a schematic exploded view illustrating the thickness detecting device of the shredder according to the second embodiment of the present invention. FIG. 12 is another schematic exploded view illustrating the thickness detecting device of the shredder according to the second embodiment of the present invention.

Please refer to FIGS. 10, 11 and 12. The adjusting device 34 comprises a first bracket 341 and a stopping block 342. The thickness detecting device 36 comprises a linking rod 361, a sheltering member 362, a sensing member 363, a second bracket 364, and a second elastic element 365. The linking rod 361 comprises plural first toothed structures 361a. The sheltering member 362 comprises a rotating disc 362a and a detecting plate 362b. The rotating disc 362a comprises plural second toothed structures 362aa. The sensing member 363 comprises a transmitting part 363a and a receiving part 363b.

Hereinafter, a process of assembling the shredder according to the second embodiment of the present invention will be illustrated with reference to FIG. 9. Firstly, the feeding channel 33 is arranged between the first lateral plate 31 and the second lateral plate 32. Then, the first bracket 341 of the adjusting device 34 is fixed on a position at a first side 31a of the first lateral plate 31. The stopping block 342 is penetrated through the first lateral plate 31 and partially exposed to the feeding channel 33. Then, the second bracket 364 of the thickness detecting device 36 is fixed on a position at a second side 32a of the second lateral plate 32. The roller 35 is pivotally coupled to the linking rod 361. Moreover, the roller 35 is penetrated through the second lateral plate 32 and partially exposed to the feeding channel 33. The roller 35 is directly aligned with the stopping block 342. The cutting blade assembly (not shown) is disposed under the feeding channel 33.

The components and assembling sequence of the adjusting device 34 are identical to those of the adjusting device 23 of the first embodiment, and are not redundantly described herein.

Hereinafter, a process of assembling the thickness detecting device 36 will be illustrated with reference to FIGS. 10, 11 and 12. Firstly, the rotating disc 362a of the sheltering member 362 is disposed within the second bracket 364, and the detecting plate 362b is connected with the rotating disc 362a. Then, the sensing member 363 is also disposed within the second bracket 364. In addition, the transmitting part 363a and the receiving part 363b are opposed to each other. The plural first toothed structures 361a of the linking rod 361 are engaged with the plural second toothed structures 362aa of the rotating disc 362a. Moreover, a first end of the linking rod 361 is pivotally coupled to the roller 35. The second elastic element 365 is connected with a second end of the linking rod 361 and sustained against the second bracket 364.

The operations of the shredder according to the second embodiment of the present invention will be illustrated in more details as follows. The position and the adjusting way of the stopping block 342 of the adjusting device 34 are identical to those of the stopping block 233 of the adjusting device 23 of the first embodiment, and are not redundantly described herein.

Firstly, a feeding gap D′ is formed between the stopping block 342 and the roller 35. After the papers in the feeding channel 33 are transferred through the feeding gap D′, the papers are cut into strips or fine particles by the cutting blade assembly (not shown). Since the thickness of the papers to be cut into strips or fine particles by the shredder 3 at one time is limited, the shredder 3 has a maximum shredding thickness value. The maximum shredding thickness value indicates the maximum allowable thickness value that can be processed by the shredder 3 at one time.

In comparison with the first embodiment, the adjusting device 34 of the shredder 3 of the second embodiment is used to assist the thickness detecting device 36. The thickness detecting device 36 is used for detecting the thickness of the papers to be cut by the shredder 3. In a case that the thickness of the papers to be cut exceeds the maximum shredding thickness value, the shredder 3 is disabled. Consequently, if no papers are transferred through the feeding gap D′, the width of the feeding gap D′ should be smaller than the maximum shredding thickness value. Whereas, if the width of the feeding gap D′ exceeds the maximum shredding thickness value, the thickness detecting device 36 is triggered. This purpose may be achieved by adjusting the distance between the stopping block 342 and the roller 35.

Moreover, if no papers are introduced into the feeding gap D′, the roller 35 and the linking rod 361 are not pushed. Meanwhile, the second elastic element 365 is not compressed. Due to the second elastic element 365, the linking rod 361 and the roller 35 are protruded toward the feeding channel 33 to the greatest extent.

More importantly, as shown in FIG. 12, the detecting plate 362b of the sheltering member 362 is not located at the region between the transmitting part 363a and the receiving part 363b of the sensing member 363 at this moment. Consequently, the sensing signal generated by the transmitting part 363a can be received by the receiving part 363b.

In a case that plural papers with the thickness greater than the width of the feeding gap D′ is started to be introduced into the feeding gap D′, the roller 35 and the linking rod 361 are pushed by the plural papers. Consequently, the rotating disc 362a is driven to be rotated by the linking rod 361. In addition, the detecting plate 362b is correspondingly swung toward the sensing member 363.

If the thickness of the plural papers exceeds the maximum shredding thickness value, the detecting plate 362b is moved to the region between the transmitting part 363a and the receiving part 363b of the sensing member 363. Consequently, the sensing signal generated by the transmitting part 363a is blocked and unable to be received by the receiving part 363b. Under this circumstance, the shredder 3 can realize that the thickness of the plural papers exceeds the maximum shredding thickness value, and thus the paper shredding operation of the shredder 3 is stopped.

From the above embodiments, it is known that the adjusting device 23 (or the adjusting device 34) may be used to adjust the width of the feeding gap D (or the feeding gap D′) to comply with the desired maximum shredding thickness value during the process of fabricating the shredder 3.

From the above descriptions, the present invention provides a shredder. It is not necessary to change the relative positions between the first lateral plate and the second lateral plate, which collaboratively define the feeding channel. That is, if the loading of the motor and the strength of the cutting blade assembly are changed, it is not necessary for the manufacturer of the shredder to destroy the original casing structure and reproduce the casing. Instead, by simply changing the relative positions between the stopping block of the adjusting device at the first lateral plate and the roller at the second lateral plate, the thickness of the papers to be introduced into the cutting blade assembly may be controlled. Consequently, regardless of the distance between the first lateral plate and the second lateral plate, a desired width of the feeding gap may be adjusted in order to comply with different specifications of various shredders.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shredder with a feeding gap adjusting device, said shredder having a maximum shredding thickness value, said shredder comprising:
a casing comprising a first lateral plate and a second lateral plate;
a feeding channel arranged between said first lateral plate and said second lateral plate for accommodating at least one paper;
an adjusting device located at a first side of said first lateral plate for adjusting a width of a feeding gap, so that said width of said feeding gap complies with said maximum shredding thickness value, wherein said adjusting device comprises:
an accommodation portion;
a first elastic element accommodated within said accommodation portion;
a stopping block for compressing said first elastic element, wherein said stopping block is partially penetrated through said first lateral plate and exposed to said feeding channel; and
a fixing element penetrated through said accommodation portion and said first elastic element and connected with said stopping block, wherein said fixing element is rotatable relative to said stopping block;
a roller penetrated through said second lateral plate and partially exposed to said feeding channel, wherein said roller is directly aligned with said stopping block, wherein said feeding gap is formed between said stopping block and said roller; and
a cutting blade assembly disposed under said feeding channel, wherein when said at least one paper is transferred through a region between said stopping block and said roller, said at least one paper is cut by said cutting blade assembly,
wherein by rotating said fixing element, said width of said feeding gap is correspondingly adjusted.

2. The shredder according to claim 1, wherein said accommodation portion further comprises two sliding grooves, and said two sliding grooves are disposed within said accommodation portion, wherein said stopping block further comprises two ribs, and said two ribs are disposed on an outer surface of said stopping block and respectively engaged with said two sliding grooves, wherein upon rotation of said fixing element, said stopping block is fixed within said accommodation portion through said two sliding grooves, so that said stopping block is not rotated with said fixing element.

3. The shredder according to claim 1, wherein said stopping block further comprises a screw hole, wherein said fixing element is a screw, and said fixing element is tightened in said screw hole.

4. The shredder according to claim 1, wherein said adjusting device further comprises a first bracket, wherein said first bracket is fixed on a position at said first side of said first lateral plate, and said accommodation portion is formed in said first bracket.

5. The shredder according to claim 1, further comprising a second bracket, wherein said second bracket is fixed on a position at a second side of said second lateral plate, wherein said roller is pivotally coupled to said second bracket.

6. The shredder according to claim 5, wherein a distance between said stopping block and said roller is equal to said maximum shredding thickness value.

7. The shredder according to claim 1, wherein a distance between said stopping block and said roller is smaller than said maximum shredding thickness value.

8. The shredder according to claim 7, further comprising a thickness detecting device, wherein said thickness detecting device comprises:
a linking rod pivotally coupled to said roller and comprising plural first toothed structures;
a sheltering member comprising a rotating disc and a detecting plate, wherein said rotating disc comprises plural second toothed structures, and said plural second toothed structures are engaged with said plural first toothed structures, wherein said detecting plate is connected with said rotating disc; and
a sensing member comprising a transmitting part for generating a sensing signal and a receiving part for receiving said sensing signal,
wherein said at least one paper comprises plural papers, wherein when said plural papers are introduced into said feeding gap, said roller and said linking rod are pushed by said plural papers, so that said rotating disc is correspondingly rotated and said detecting plate is swung, wherein if said thickness of said plural papers exceeds said maximum shredding thickness value, said sensing signal is blocked by said detecting plate.

9. The shredder according to claim 8, wherein said thickness detecting device further comprises a second bracket and a second elastic element, wherein said second bracket is fixed on a position at a second side of said second lateral plate, wherein said linking rod, said sheltering member and said sensing member are all disposed within said second bracket, and said second elastic element is connected with said linking rod and sustained against said second bracket.

10. The shredder according to claim 1, wherein said stopping block has a first end and a second end, wherein said first elastic element is compressed by said first end of said stopping block, said second end of said stopping block is exposed to said feeding channel, and said second end of said stopping block has a slant surface for facilitating said at least one paper to pass through.
